(19) United States
(12) Patent Application Publication
(10) Pub. No.: US 2025/0383951 A1
(43) Pub. Date: Dec. 18, 2025

(54) Per-Neighborhood Drive Firmware Update Parallelism for a Scale-Out Clustered File System

(71) Applicant: Dell Products L.P., Round Rock, TX (US)

(72) Inventors: Steven Soumpholphakdy, Austin, TX (US); Daniel Ryan, Minneapolis, MN (US); Mark Ranger, Seattle, WA (US)

(21) Appl. No.: 18/742,705

(22) Filed: Jun. 13, 2024

(51) Int. Cl. G06F 11/07

(52) U.S. Cl. CPC G06F 11/079; G06F 11/0709

(57) ABSTRACT

A system can maintain a computer cluster that comprises a group of nodes, wherein a node of the group of nodes comprises a group of storage drives, wherein the node is a member of a failure domain that comprises a subgroup of nodes of the group of nodes, wherein the failure domain is configured to preserve data stored in the failure domain when at least one node within the failure domain fails. The system can obtain a reservation for the node, wherein the reservation permits the node to make the group of storage drives unavailable for data access, and wherein other nodes within the failure domain are unable to obtain the reservation while the node possesses the reservation. The system can, while the node possesses the reservation, update firmware for respective storage drives for the group of storage drives in parallel.

### BACKGROUND

Computer storage drives can store data, and can also comprise firmware, which can be updated.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can maintain a computer cluster that comprises a group of nodes, wherein a node of the group of nodes comprises a group of storage drives, wherein the node is a member of a failure domain that comprises a subgroup of nodes of the group of nodes, wherein the failure domain is configured to preserve data stored in the failure domain when at least one node within the failure domain fails. The system can obtain a reservation for the node, wherein the reservation permits the node to make the group of storage drives unavailable for data access, and wherein other nodes within the failure domain are unable to obtain the reservation while the node possesses the reservation. The system can, while the node possesses the reservation, update firmware for respective storage drives for the group of storage drives in parallel.

An example method can comprise determining, by a system comprising at least one processor, to update firmware for a group of storage drives of a group of nodes, wherein a node of the group of nodes is a member of a failure domain. The method can further comprise obtaining, by the system, a reservation for the node, wherein other nodes within the failure domain are unable to obtain the reservation while the node possesses the reservation. The method can further comprise, while the node possesses the reservation, concurrently updating, by the system, the firmware for respective storage drives for the group of storage drives.

An example non-transitory computer-readable medium can comprise instructions that, in response to execution, cause a system comprising a processor to perform operations. These operations can comprise obtaining a reservation for a node of a failure domain, wherein other nodes within the failure domain are unable to obtain the reservation while the node possesses the reservation. These operations can further comprise, while the node possesses the reservation, updating firmware for respective storage drives of the node in parallel.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate per-neighborhood drive firmware update parallelism for a scale-out clustered file system, in accordance with an embodiment of this disclosure;

FIG. 2 illustrates an example signal flow that can facilitate per-neighborhood drive firmware update parallelism for a scale-out clustered file system, in accordance with an embodiment of this disclosure;

FIG. 3 illustrates an example process flow that can facilitate per-neighborhood drive firmware update parallelism for a scale-out clustered file system, in accordance with an embodiment of this disclosure;

FIG. 4 illustrates another example process flow that can facilitate per-neighborhood drive firmware update parallelism for a scale-out clustered file system, in accordance with an embodiment of this disclosure;

FIG. 5 illustrates another example process flow that can facilitate per-neighborhood drive firmware update parallelism for a scale-out clustered file system, in accordance with an embodiment of this disclosure;

FIG. 6 illustrates another example process flow that can facilitate per-neighborhood drive firmware update parallelism for a scale-out clustered file system, in accordance with an embodiment of this disclosure;

FIG. 7 illustrates another example process flow that can facilitate per-neighborhood drive firmware update parallelism for a scale-out clustered file system, in accordance with an embodiment of this disclosure;

FIG. 8 illustrates another example process flow that can facilitate per-neighborhood drive firmware update parallelism for a scale-out clustered file system, in accordance with an embodiment of this disclosure;

FIG. 9 illustrates another example process flow that can facilitate per-neighborhood drive firmware update parallelism for a scale-out clustered file system, in accordance with an embodiment of this disclosure;

FIG. 10 illustrates another example process flow that can facilitate per-neighborhood drive firmware update parallelism for a scale-out clustered file system, in accordance with an embodiment of this disclosure;

FIG. 11 illustrates an example block diagram of a computer operable to execute an embodiment of this disclosure.

### DETAILED DESCRIPTION

### Overview

In a storage cluster, a neighborhood can comprise disk pools within a node boundary, aligned with the disk pools' node boundaries. Generally, a node can be a member of one neighborhood, while comprising drives in multiple disk pools.

In prior approaches, a capability to perform cluster-wide drive firmware update can have several inefficiencies. These prior approaches can involve cycling serially node-by-node within the cluster, cycling serially drive-by-drive on a given node, and non-optimized logic to rebalance mirrors for platforms leveraging mirrored partitions on data drives.

A reason to serialize drive firmware updates at the per-node and per-drive level can be to ensure that data unavailability is not incurred when multiple drives are taken down to perform an update.

As for the handling of the mirrored partitions, prior approaches can involve rebalancing mirrored partitions from the drive to be upgraded to ensure that an active mirror is always up. This can cover a scenario where there could be degradation down to a single mirror of the pair, and the drive that contains the single mirror fails. Rebalancing for each drive can be inefficient, since it can be that a partition is moved N times, where N is the number of drives on a given node. In contrast, the present techniques can be implemented with only two mirror rebalances, regardless of a number of drives on a node.

The upgrade process can be improved to speed up completion time. A diskpool (e.g. collection of storage drives) database application programming interface (API) can facilitate determining whether a set of nodes or drives can be removed from a cluster without incurring data unavailability by the upgrade framework, to sequence multiple drives (and subsequently whole nodes) to be upgraded at the same time. Using this API, an existing cluster-wide non-disruptive drive firmware update can be augmented to update multiple drives at a time. In doing so, there can be a desire to ensure that no mirrored partitions are degraded.

The present techniques can be implemented to facilitate achieving this goal, through accounting for an availability of data and health of mirrored partitions to speed up completion time on a per-node basis.

In prior approaches, a cluster-wide drive firmware update solution can be executed as follows:
1. Start the cluster-wide drive firmware update via a command line interface (CLI)/performance API (PAPI)
2. This can signal to a drive management daemon for all nodes that it is to start a firmware update.
3. Each node can try to acquire a cluster-wide drive firmware update lock.
   a. Nodes that have not acquired the lock can sleep until they can acquire it.
4. The node that has acquired the lock can:
   a. Cycle serially through each drive in the node and execute the following:
      i. Take down the drive to ensure all filesystem input/output (IO) is quiesced to the drive;
      ii. Rebalance mirrored operating system (OS) partitions (where supported by a platform);
      iii. Perform the drive firmware update for the given drive.
5. Once complete, the node can release the lock.
6. Remaining nodes in the cluster can obtain the lock and execute steps 3-5 until all nodes have completed the process.

In some examples, the present techniques can be implemented to improve steps 3-6.

With the present techniques, instead of having a global lock for each node to cycle through the drive firmware updates, the reservation can serve as a neighborhood-wide lock. That is, if a node has a reservation for a given set of drives, it can be that no other node can take the reservation until it is released.

Using a reservation API as a global lock can facilitate performing drive firmware updates on multiple neighborhoods in parallel. Within a neighborhood, each node can have drive-firmware-update parallelism.

As part of the drive firmware update process, it can be that a drive is taken down to perform the drive update, which can have potential risks of data unavailability, or degraded OS partitions. The present techniques can be implemented to ensure that multiple drives can be updated at the same time without encountering risk of either.

Facilitating per-node drive firmware update parallelism can involve determining whether a platform supports mirrored OS partitions.

If the platform does not support mirrored OS partition, that can mean that the OS lives on dedicated boot drives, so rebalancing OS partitions can be omitted. This can further mean that a single drive group can be created, which includes all drives in the node, to update in parallel.

If the platform supports mirrored partitions, there can be a need to determine a number of OS partitions per drive. Once there is a mapping of the number of OS partitions to drive, the OS partitions can be sorted from highest to lowest numbers of partitions. Using this sorted list, the drives can be split into two different drive groups. The drives with the higher number of partitions can fall into the first group, and the drives with the lower number of partitions can fall into the second group. Sorting in this manner can facilitate pivoting partitions to drives that have more free space in a dedicated region for a mirrored partition.

It can be that a dedicated region for a mirrored partition can be sized in a way that ensures that in a worst case scenario where there are four drives, OS partitions can reside on the other half of drives in the system.

After the drives have been split into drive groups, each of these drive groups can be iterated through, and actions to update the drives can be performed. For each drive group, the non-healthy drives can be filtered. Then, a reservation can be taken for a given node and identifiers (e.g., logical drive numbers (LNUMs) assigned to each of the drives in the drive group. If that succeeds, it can be determined that the drives can be taken down without incurring data unavailability.

The mirrors can be rebalanced (in examples where this is supported on the platform). In the rebalance, all the drives within the drive group can be excluded. Doing so can ensure that the rebalance will be made to the other drives in the node.

Once the mirrors have rebalanced, an attempt can be made to take a reservation. If the reservation can be taken, the firmware update can be executed. If not, then updating the firmware can wait until a reservation can be taken.

In the case where the reservation can be taken, the firmware update can be performed for all the drives in the drive group. This can involve downing all the drives within that group and updating their firmware. Once done, the reservation can be released.

From the cluster point of view, each node can attempt to take a reservation to perform its firmware updates. The cluster-wide drive firmware update can be deemed complete once all nodes have taken a reservation for each of the drive groups in their update groups and those drives have had their firmware updated.

The present techniques can facilitate parallel drive updates while accounting for data unavailability and mirrored OS partitions.

These approaches can facilitate updating multiple neighborhoods at a time and within each node in that neighborhood, there can be an ability to update multiple drives at the same time while ensuring data is available and that mirrored OS partitions are not degraded. This brings forth timing optimizations as this improves from:

<time to update drive>*<Number of drives in the node>*<Number of Nodes in the Cluster>

to

<Time to update drive>*2*<Number of Nodes in a Neighborhood>

where 2 is the number of drive groups identified from creating the mapping of number of partitions per drive in the given node.

Furthermore, time can be saved on mirrored OS partition systems because there is not a rebalance for every drive. Instead, rebalancing can be performed based on the number of drive groups (2).

Prior approaches are generally serial, and not optimized for time to completion. The present techniques can be implemented to solve a per-node parallelism problem, and facilitate updating multiple neighborhoods at the same time.

It can be that improving per-node parallelism can be done in other ways, but those solutions would not maintain data availability or allow the node to stay up to execute code during the process—for example, a simultaneous update that would down all drives so there are no active partitions, and there is data unavailability.

It can be appreciated that there can be examples where the present techniques can be applied to nodes living in a neighborhood fault domain. Then, for the drives themselves, it can be that due different functional aspects of how drives used, functional domains can be accounted for in such a way that the node is not rendered unusable, but rather the present techniques can account for this aspect on top of the fault domain at the neighborhood level.

### Example Architecture

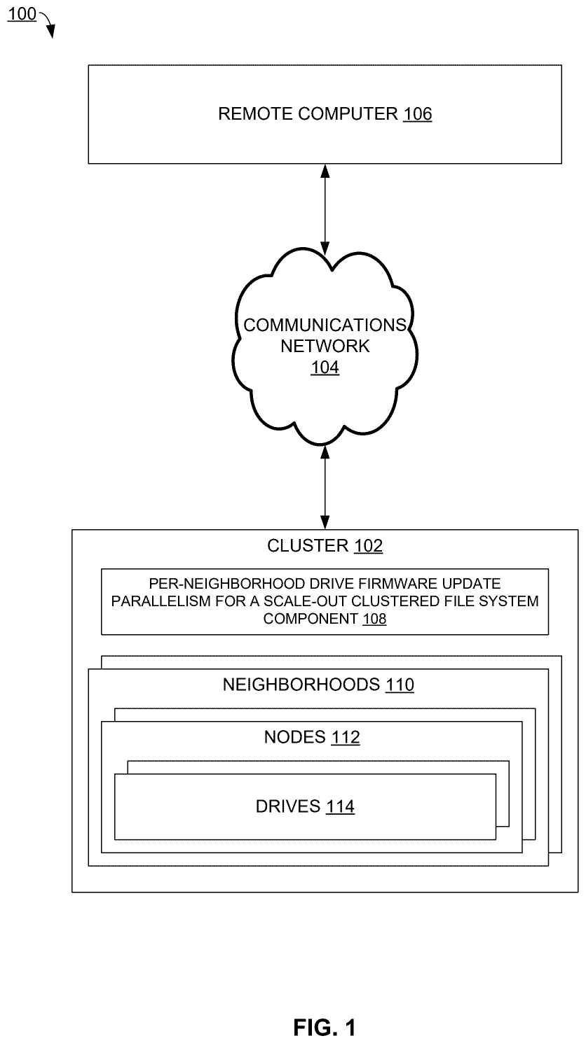

FIG. 1 illustrates an example system architecture 100 that can facilitate per-neighborhood drive firmware update parallelism for a scale-out clustered file system, in accordance with an embodiment of this disclosure.

System architecture 100 comprises cluster 102, communications network 104, and remote computer 106. In turn, cluster 102 comprises per-neighborhood drive firmware update parallelism for a scale-out clustered file system component 108, neighborhoods 110, nodes 112, and drives 114.

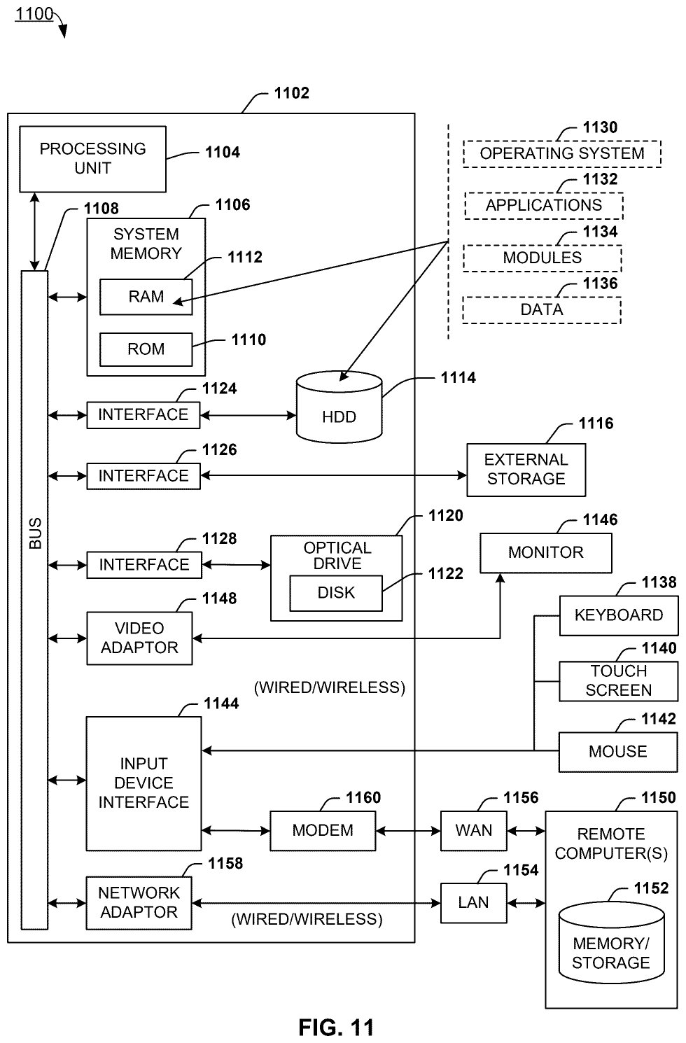

Each of cluster 102 and/or remote computer 106 can be implemented with part(s) of computing environment 1100 of FIG. 11. Communications network 104 can comprise a computer communications network, such as the Internet.

A cluster can comprise multiple neighborhoods 110 of nodes 112, and nodes 112 can comprise multiple drives 114.

For nodes within a neighborhood, per-neighborhood drive firmware update parallelism for a scale-out clustered file system component 108 can facilitate updating the drive firmware of these nodes in series (while updating the drives themselves in parallel, and updating different neighborhoods in parallel). This updating can be triggered by an instruction from remote computer 106.

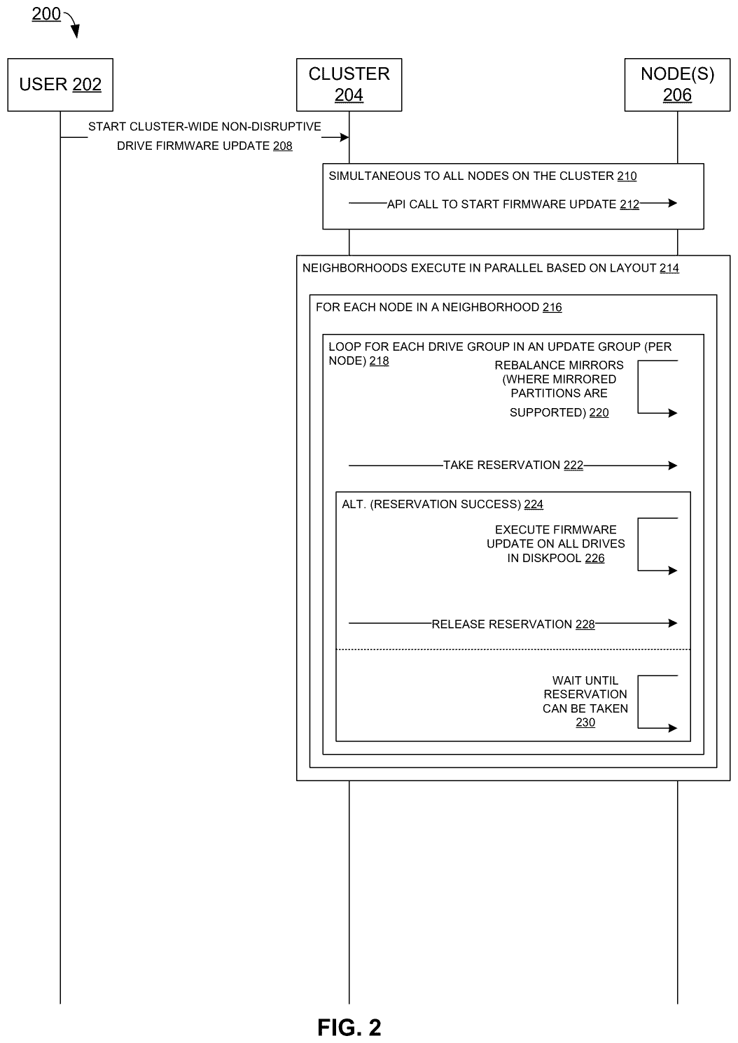

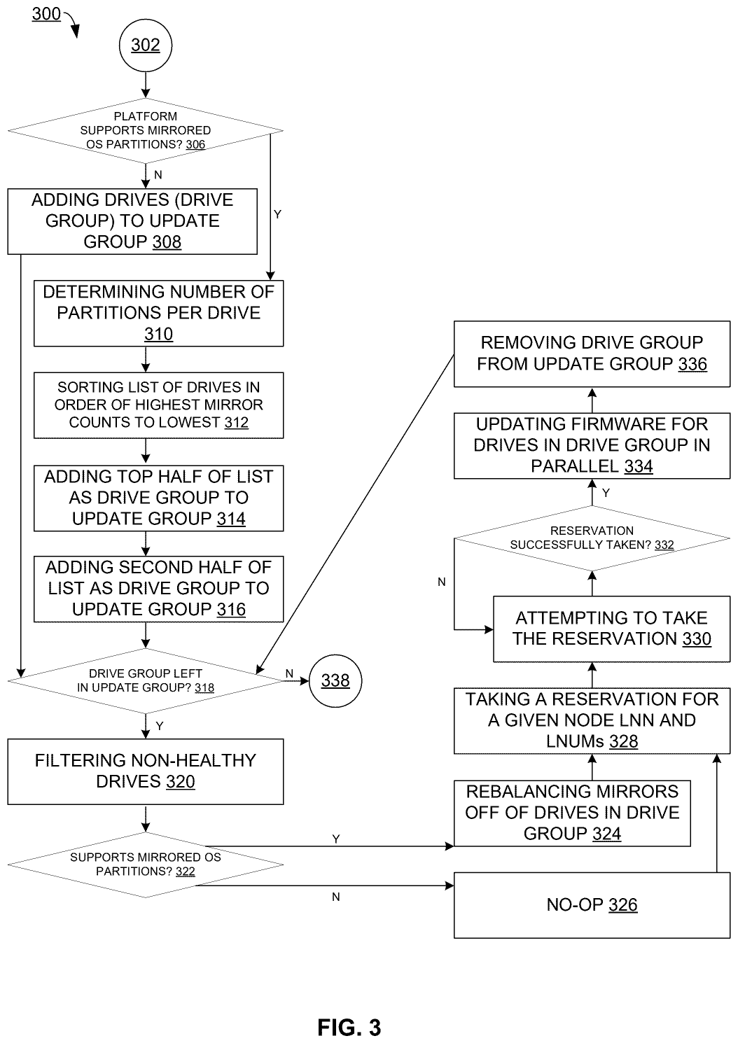

In some examples, per-neighborhood drive firmware update parallelism for a scale-out clustered file system component 108 can implement part(s) of the signal flow of FIG. 2, and/or the process flows of FIGS. 3-10 to facilitate per-neighborhood drive firmware update parallelism for a scale-out clustered file system.

It can be appreciated that system architecture 100 is one example system architecture for proactive prevention of data unavailability and data loss, and that there can be other system architectures that facilitate per-neighborhood drive firmware update parallelism for a scale-out clustered file system.

### Example Signal Flow

FIG. 2 illustrates an example signal flow 200 that can facilitate per-neighborhood drive firmware update parallelism for a scale-out clustered file system, in accordance with an embodiment of this disclosure. In some examples, part(s) of signal flow 200 can be used to implement part(s) of system architecture 100 of FIG. 1.

Signal flow 200 comprises signals between user 202, cluster 204, and node(s) 206. These signals (and indications of performing signals in parallel and looping) are:
Start cluster-wide non-disruptive drive firmware update 208.
Simultaneous to all nodes on the cluster 210
API call to start firmware update 212
Neighborhoods execute in parallel based on layout 214
For each node in a neighborhood 216
Loop for each drive group in an update group (per node) 218
Rebalance mirrors (where mirrored partitions are supported) 220
Take reservation 222
Alt. (reservation success) 224
Execute firmware update on all drives in diskpool 226
Release reservation 228
Wait until reservation can be taken 230

In this manner, each instance of a drive daemon can be instructed to start a firmware update for a corresponding drive. Each node can cycle through its own set of diskpools. A reservation API can serve as a lock, so each node can attempt to use a reservation for a given set of drives, then perform an update, then release a reservation. At that point, another node in that neighborhood can take the reservation next. This can continue until all drives on a node have been updated, for all nodes in a cluster.

### Example Process Flows

FIG. 3 illustrates an example process flow 300 for per-neighborhood drive firmware update parallelism for a scale-out clustered file system, in accordance with an embodiment of this disclosure. In some examples, one or more embodiments of process flow 300 can be implemented by system architecture 100 of FIG. 1, or computing environment 1100 of FIG. 11.

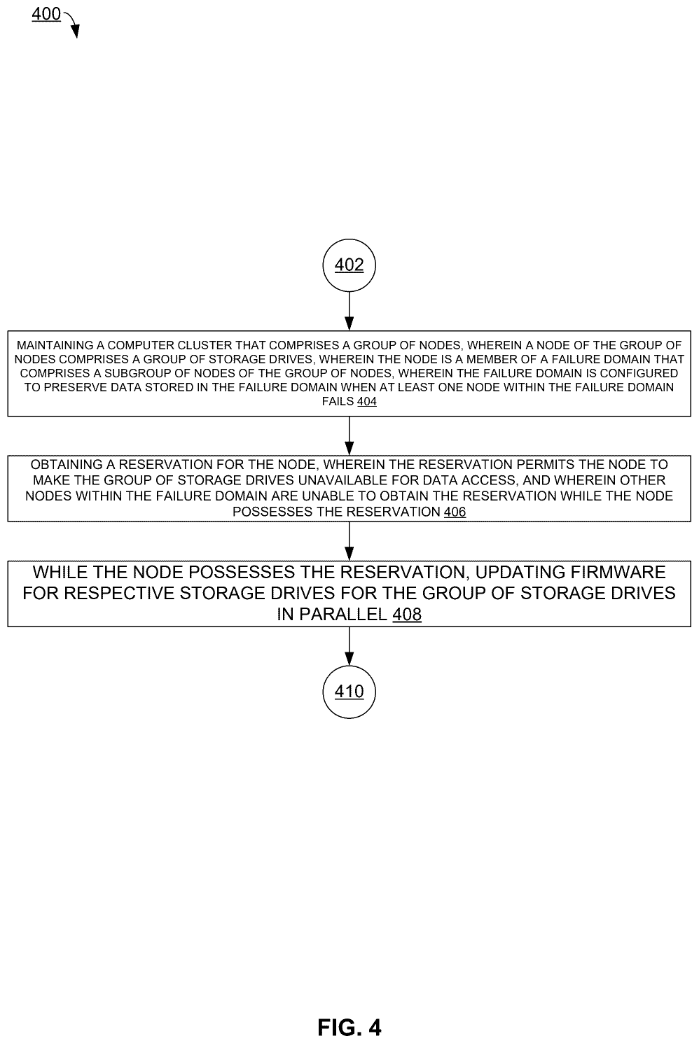

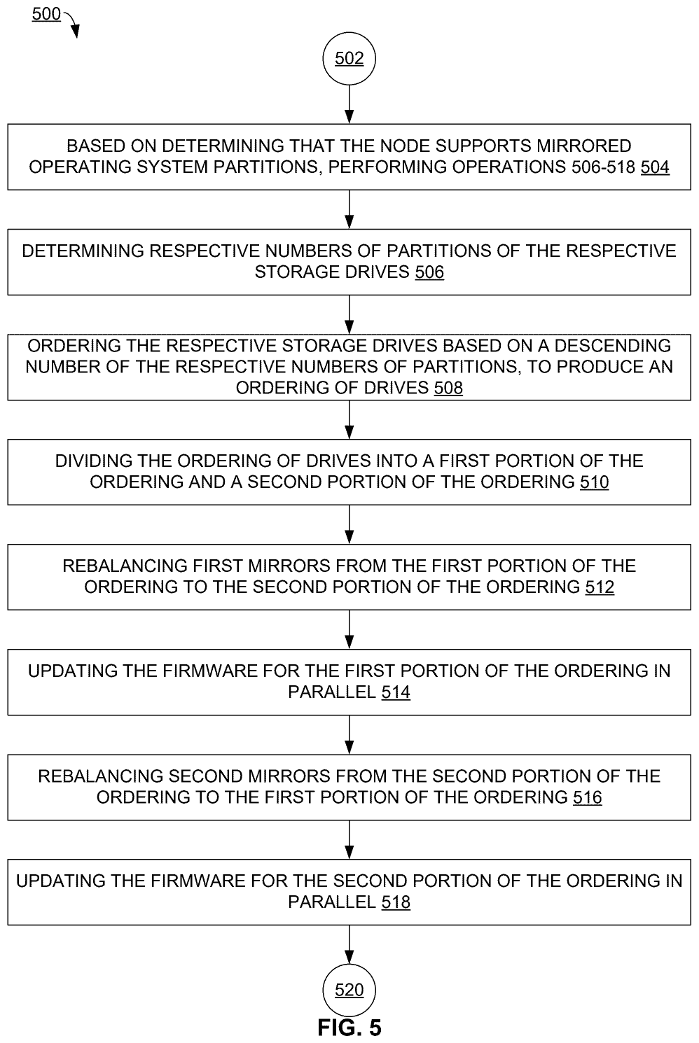

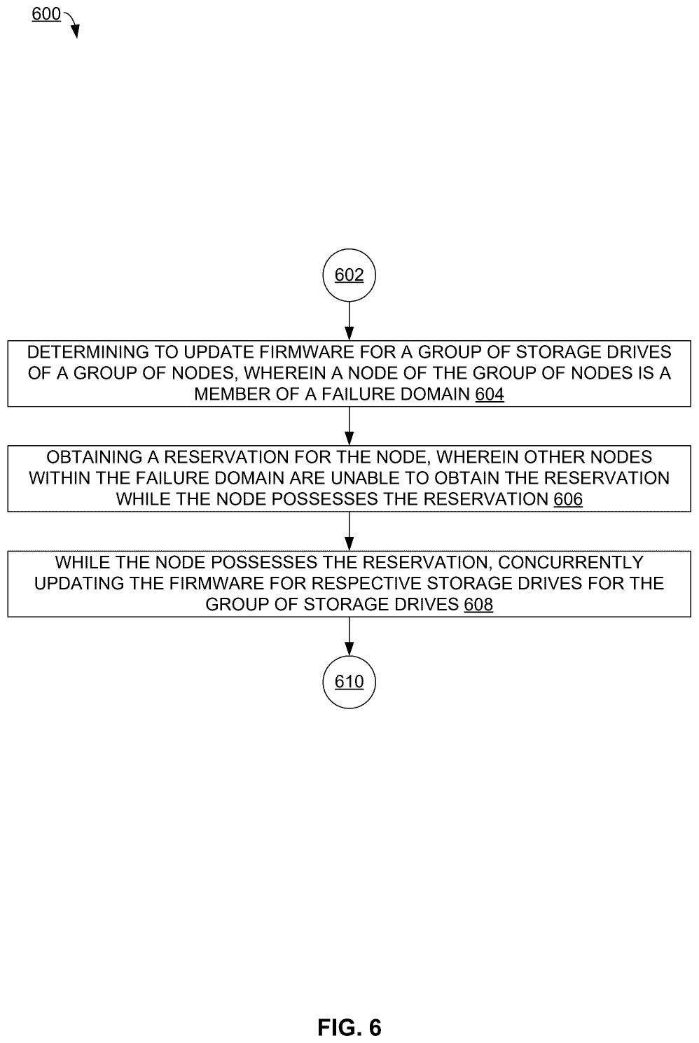

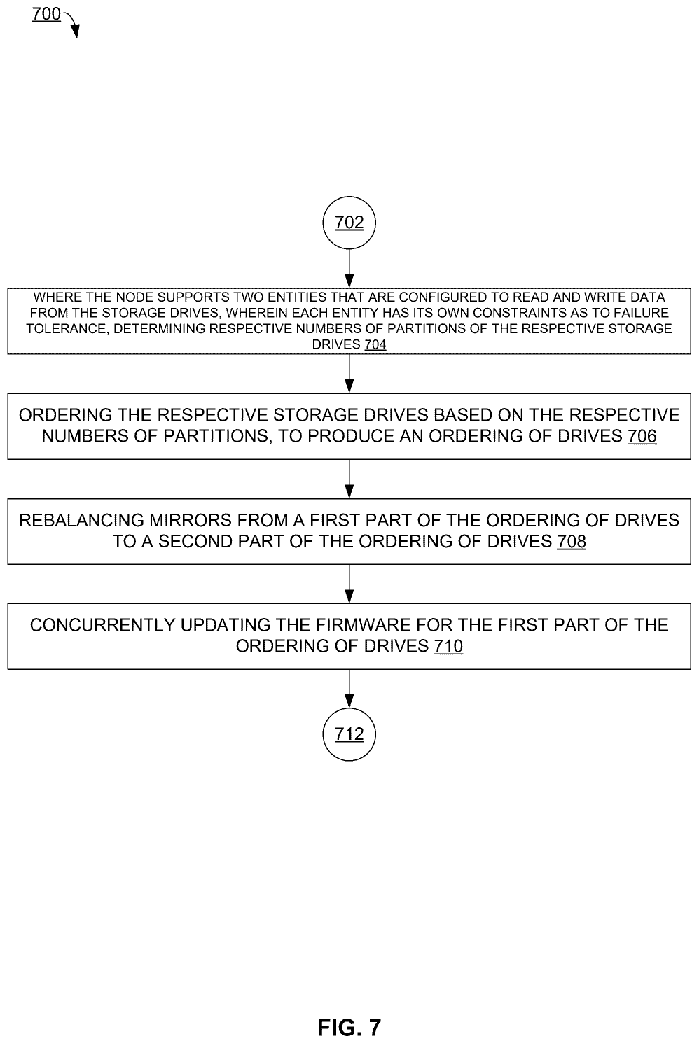

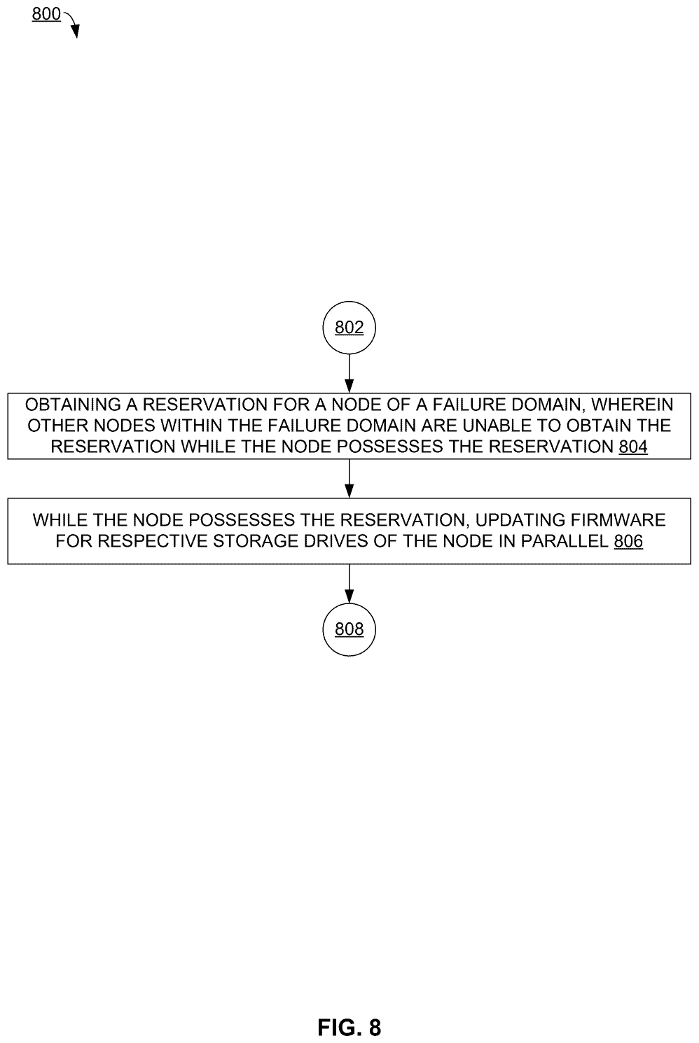

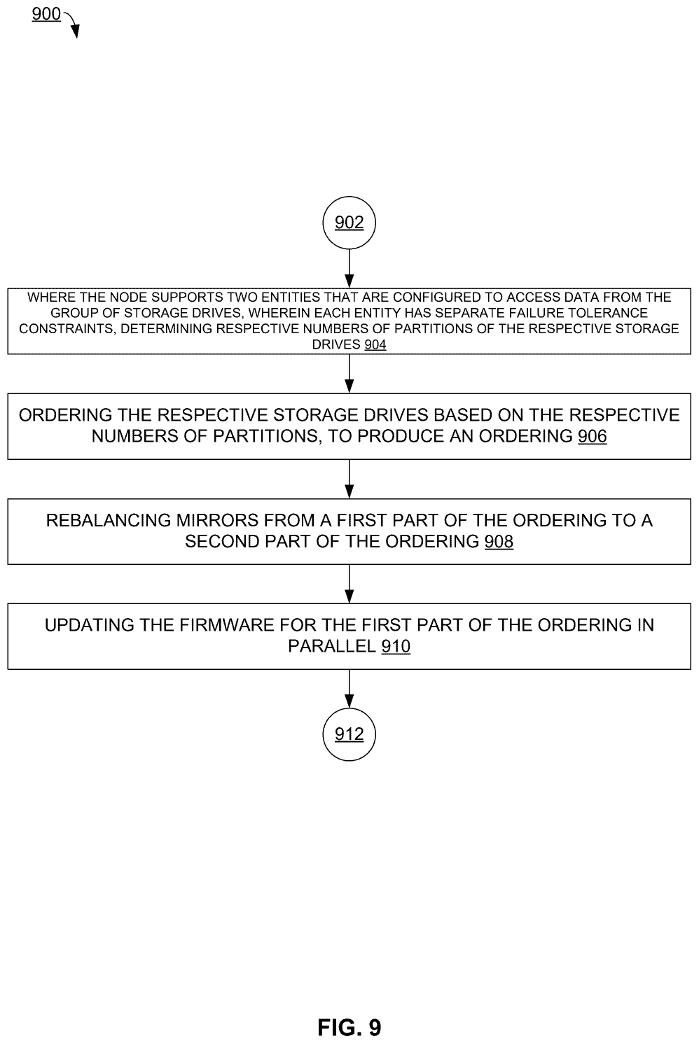

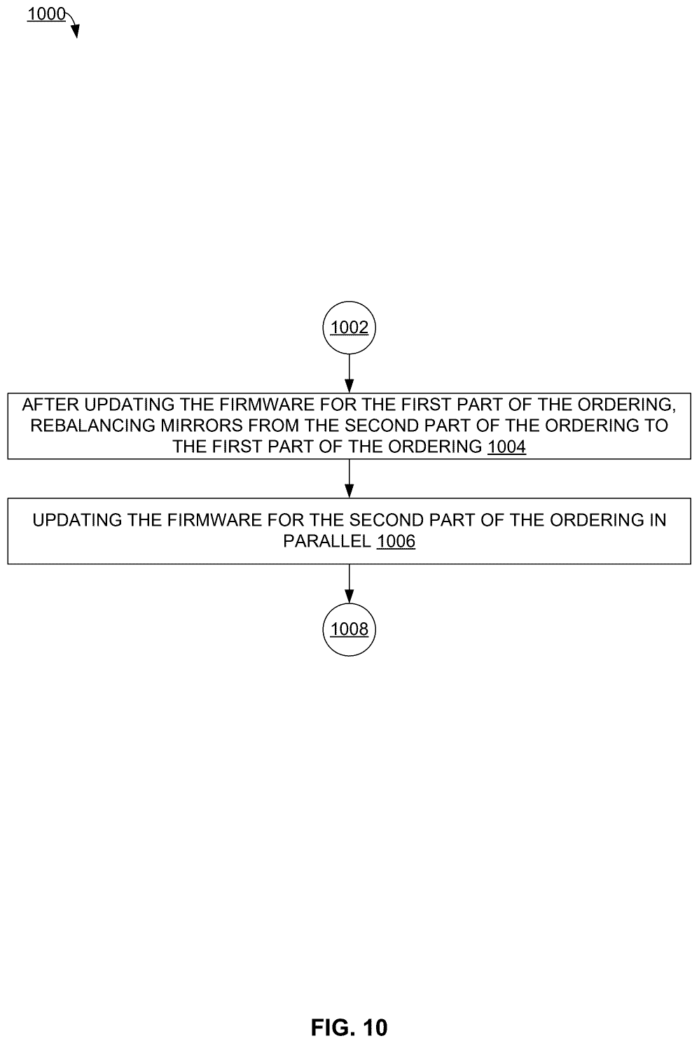

It can be appreciated that the operating procedures of process flow 300 are example operating procedures, and that there can be embodiments that implement more or fewer operating procedures than are depicted, or that implement the depicted operating procedures in a different order than as depicted. In some examples, process flow 300 can be implemented in conjunction with one or more embodiments of one or more of process flow 400 of FIG. 4, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 300 begins with 302, and comprises the following operations:
Platform supports mirrored operating system partitions? 306 (Yes: go to 310; No: go to 308)
Adding drives (drive group) to update group 308
Determining number of partitions per drive 310
Sorting list of drives in order of highest mirror counts to lowest 312
Adding top half of list as drive group to update group 314
Adding second half of list as drive group to update group 316
Drive group left in update group? 318 (Yes: go to 320; No: go to 338)
Filtering non-healthy drives 320
Supports mirrored OS partitions? 322 (Yes: go to 324; No: go to 326)
Rebalancing mirrors off of drives in drive group 324
No-op 326
Taking a reservation for a given node LNN and drives (e.g., identified by logical numbers (LNUMs)) 328
Attempting to take the reservation 330
Reservation successfully taken? 332 (Yes: go to 334; No: go to 330)
Updating firmware for drives in drive group in parallel 334
Removing drive group from update group 336

Process flow 300 ends with 338.

FIG. 4 illustrates an example process flow 400 for per-neighborhood drive firmware update parallelism for a scale-out clustered file system, in accordance with an embodiment of this disclosure. In some examples, one or more embodiments of process flow 400 can be implemented by system architecture 100 of FIG. 1, or computing environment 1100 of FIG. 11.

It can be appreciated that the operating procedures of process flow 400 are example operating procedures, and that there can be embodiments that implement more or fewer operating procedures than are depicted, or that implement the depicted operating procedures in a different order than as depicted. In some examples, process flow 400 can be implemented in conjunction with one or more embodiments of one or more of process flow 300 of FIG. 3, process flow 500 of FIG. 5, process flow 600 of FIG. 6, process flow 700 of FIG. 7, process flow 800 of FIG. 8, process flow 900 of FIG. 9, and/or process flow 1000 of FIG. 10.

Process flow 400 begins with 402, and moves to operation 404.

Operation 404 depicts maintaining a computer cluster that comprises a group of nodes, wherein a node of the group of nodes comprises a group of storage drives, wherein the node is a member of a failure domain that comprises a subgroup of nodes of the group of nodes, wherein the failure domain is configured to preserve data stored in the failure domain when at least one node within the failure domain fails. That is, there can be a storage cluster that comprises node, where nodes can comprise at least one drive, and nodes are grouped into neighborhoods.

After operation 404, process flow 400 moves to operation 406.

Operation 406 depicts obtaining a reservation for the node, wherein the reservation permits the node to make the group of storage drives unavailable for data access, and wherein other nodes within the failure domain are unable to obtain the reservation while the node possesses the reservation. That is, a node can take a reservation within its neighborhood. It can be that taking the reservation means that the drives can be taken down, while data is still available to a user (that is, data can be provided from other drives in the cluster).

After operation 406, process flow 400 moves to operation 408.

Operation 408 depicts, while the node possesses the reservation, updating firmware for respective storage drives for the group of storage drives in parallel. That is, for a node with a reservation, its drives' firmware can be updated in parallel. The nodes of a neighborhood can have their drives updated in series.

In some examples, the node is a first node, and operation 408 comprises updating the firmware for the node sequentially with updating the firmware for a second node of the failure domain. That is, drives of a node can be updated in parallel, and different nodes can be updated in series.

In some examples, the second node obtains the reservation before updating the firmware for the second node. That is, nodes within a failure domain can use the same reservation for determining when they can update their drives (which can enforce updating nodes in series).

In some examples, the failure domain is a first failure domain, and operation 408 comprises updating the firmware on the first failure domain in parallel with updating the firmware on a second failure domain. That is, two different failure domains can be updated in parallel.

In some examples, the reservation is a first reservation of the first failure domain, and updating the firmware on the second failure domain comprises nodes of the second failure domain obtaining a second reservation of the second failure domain. That is, different failure domains can use different reservations.

In some examples, operation 408 comprises filtering out drives from the group of storage drives that fail to satisfy a health criterion, to produce a filtered group of storage drives, wherein the updating of the firmware is performed on the filtered group of storage drives. That is, non-healthy drives can be those for which a firmware update cannot be performed, and these non-healthy drives can be removed from consideration as part of updating the firmware for drives.

After operation 408, process flow 400 moves to 410, where process flow 400 ends.

FIG. 5 illustrates an example process flow 500 for per-neighborhood drive firmware update parallelism for a scale-out clustered file system, in accordance with an embodiment of this disclosure. In some examples, one or more embodiments of process flow 500 can be implemented by system architecture 100 of FIG. 1, or computing environment 1100 of FIG. 11.

It can be appreciated that the operating procedures of process flow 500 are example operating procedures, and that there can be embodiments that implement more or fewer operating procedures than are depicted, or that implement the depicted operating procedures in a different order than as depicted. In some examples, process flow 500 can be implemented in conjunction with one or more embodiments of one or more of process flow 300 of FIG. 3, process flow 400 of FIG. 4, process flow 600 of FIG. 6, process flow 700 of FIG. 7, process flow 800 of FIG. 8, process flow 900 of FIG. 9, and/or process flow 1000 of FIG. 10.

Process flow 500 begins with 502, and moves to operation 504.

Operation 504 depicts, based on determining that the node supports mirrored operating system partitions, performing operations 506-518. In some examples, a node can be referred to as a platform. In some examples, specific node variants can have certain capabilities, and mirrored operating system partitions can be a capability of a node.

After operation 504, process flow 500 moves to operation 506.

Operation 506 depicts determining respective numbers of partitions of the respective storage drives. This can be implemented in a similar manner as operation 310 of FIG. 3.

After operation 506, process flow 500 moves to operation 508.

Operation 508 depicts ordering the respective storage drives based on a descending number of the respective numbers of partitions, to produce an ordering of drives. This can be implemented in a similar manner as operation 312 of FIG. 3.

After operation 508, process flow 500 moves to operation 510.

Operation 510 depicts dividing the ordering of drives into a first portion of the ordering and a second portion of the ordering. This can be implemented in a similar manner as operations 312-314 of FIG. 3.

After operation 510, process flow 500 moves to operation 512.

Operation 512 depicts rebalancing first mirrors from the first portion of the ordering to the second portion of the ordering. This can be implemented in a similar manner as operation 324 of FIG. 3.

After operation 512, process flow 500 moves to operation 514.

Operation 514 depicts updating the firmware for the first portion of the ordering in parallel. This can be implemented in a similar manner as operation 334 of FIG. 3.

After operation 514, process flow 500 moves to operation 516.

Operation 516 depicts rebalancing second mirrors from the second portion of the ordering to the first portion of the ordering. This can be implemented in a similar manner as operation 324 of FIG. 3.

In general, partitions can be moved to a group of drives that will not be updated. In some examples, after a first round of updates are done, the partitions can be rebalanced from the second group back to the first, such that the second group can then be updated.

After operation 516, process flow 500 moves to operation 518.

Operation 518 depicts updating the firmware for the second portion of the ordering in parallel. This can be implemented in a similar manner as operation 334 of FIG. 3.

After operation 518, process flow 500 moves to 520, where process flow 500 ends.

FIG. 6 illustrates an example process flow 600 for per-neighborhood drive firmware update parallelism for a scale-out clustered file system, in accordance with an embodiment of this disclosure. In some examples, one or more embodiments of process flow 600 can be implemented by system architecture 100 of FIG. 1, or computing environment 1100 of FIG. 11.

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 300 of FIG. 3, process flow 400 of FIG. 4, process flow 500 of FIG. 5, process flow 700 of FIG. 7, process flow 800 of FIG. 8, process flow 900 of FIG. 9, and/or process flow 1000 of FIG. 10.

Process flow 600 begins with 602, and moves to operation 604.

Operation 604 depicts determining to update firmware for a group of storage drives of a group of nodes, wherein a node of the group of nodes is a member of a failure domain. In some examples, operation 604 can be implemented in a similar manner as operation 404 of FIG. 4.

After operation 604, process flow 600 moves to operation 606.

Operation 606 depicts obtaining a reservation for the node, wherein other nodes within the failure domain are unable to obtain the reservation while the node possesses the reservation. In some examples, operation 606 can be implemented in a similar manner as operation 406 of FIG. 4.

In some examples, obtaining the reservation for the node comprises performing at least one iteration of attempting to obtain the reservation until obtaining the reservation succeeds, and updating the firmware after obtaining the reservation succeeds. In some examples, attempting to obtain the reservation succeeds where no other node of the failure domain has the reservation. In some examples, attempting to obtain the reservation fails where another node of the failure domain has the reservation. That is, there can be a wait-loop on a node taking a reservation, and other nodes in the node's failure domain can be in contention for the reservation.

After operation 606, process flow 600 moves to operation 608.

Operation 608 depicts, while the node possesses the reservation, concurrently updating the firmware for respective storage drives for the group of storage drives. In some examples, operation 608 can be implemented in a similar manner as operation 408 of FIG. 4.

In some examples, operation 608 comprises releasing the reservation after concurrently updating the firmware for the respective storage drives for the group of storage drives. That is, once a node has updated the firmware of its drives, it can release its reservation so another node in its failure domain can obtain the reservation (and then update the firmware of its drives).

After operation 608, process flow 600 moves to 610, where process flow 600 ends.

FIG. 7 illustrates an example process flow 700 for per-neighborhood drive firmware update parallelism for a scale-out clustered file system, in accordance with an embodiment of this disclosure. In some examples, one or more embodiments of process flow 700 can be implemented by system architecture 100 of FIG. 1, or computing environment 1100 of FIG. 11.

It can be appreciated that the operating procedures of process flow 700 are example operating procedures, and that there can be embodiments that implement more or fewer operating procedures than are depicted, or that implement the depicted operating procedures in a different order than as depicted. In some examples, process flow 700 can be implemented in conjunction with one or more embodiments of one or more of process flow 300 of FIG. 3, process flow 400 of FIG. 4, process flow 500 of FIG. 5, process flow 600 of FIG. 6, process flow 800 of FIG. 8, process flow 900 of FIG. 9, and/or process flow 1000 of FIG. 10.

Process flow 700 begins with 702, and moves to operation 704.

Operation 704 depicts, where the node supports two entities that are configured to read and write data from the storage drives, wherein each entity has its own constraints as to failure tolerance, determining respective numbers of partitions of the respective storage drives. This can be implemented in a similar manner as operation 310 of FIG. 3.

After operation 704, process flow 700 moves to operation 706.

Operation 706 depicts ordering the respective storage drives based on the respective numbers of partitions, to produce an ordering of drives. This can be implemented in a similar manner as operation 312 of FIG. 3.

After operation 706, process flow 700 moves to operation 708.

Operation 708 depicts rebalancing mirrors from a first part of the ordering of drives to a second part of the ordering of drives. This can be implemented in a similar manner as operation 324 of FIG. 3.

After operation 708, process flow 700 moves to operation 710.

Operation 710 depicts concurrently updating the firmware for the first part of the ordering of drives. This can be implemented in a similar manner as operation 334 of FIG. 3.

In some examples, operation 710 comprises, after updating the firmware for

the first part of the ordering, rebalancing mirrors from the second part of the ordering of drives to the first part of the ordering of drives, and concurrently updating the firmware for the second part of the ordering of drives. This can be implemented in a similar manner as operations 324 and 334 of FIG. 3.

After operation 710, process flow 700 moves to 712, where process flow 700 ends.

FIG. 8 illustrates an example process flow 800 for per-neighborhood drive firmware update parallelism for a scale-out clustered file system, in accordance with an embodiment of this disclosure. In some examples, one or more embodiments of process flow 800 can be implemented by system architecture 100 of FIG. 1, or computing environment 1100 of FIG. 11.

It can be appreciated that the operating procedures of process flow 800 are example operating procedures, and that there can be embodiments that implement more or fewer operating procedures than are depicted, or that implement the depicted operating procedures in a different order than as depicted. In some examples, process flow 800 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 900 of FIG. 9, and/or process flow 1000 of FIG. 10.

Process flow 800 begins with 802, and moves to operation 804.

Operation 804 depicts obtaining a reservation for a node of a failure domain, wherein other nodes within the failure domain are unable to obtain the reservation while the node possesses the reservation. In some examples, operation 804 can be implemented in a similar manner as operation 406 of FIG. 4.

In some examples, a computer cluster comprises the failure domain, user input data that is indicative of starting a firmware update is received from a computer at a cluster management component of the system, and the cluster management component sends the node an indication to start the firmware update. This can be implemented in a similar manner as 208-212 of FIG. 2.

After operation 804, process flow 800 moves to operation 806.

Operation 806 depicts, while the node possesses the reservation, updating firmware for respective storage drives of the node in parallel. In some examples, operation 806 can be implemented in a similar manner as operation 408 of FIG. 4.

In some examples, a computer cluster comprises a group of failure domains, the group of failure domains comprises the failure domain, and a firmware update for the computer cluster is determined to be complete where respective firmware updates for respective failure domains of the group of failure domains are complete. That is, a cluster-wide drive firmware update can be deemed complete where all nodes have taken a reservation for each of the drive groups in their update group, and those drives have had their firmware updated.

In some examples, updating the firmware for the respective storage drives is performed after removing the respective storage drives from a user-facing file system. That is, drives can be removed from a user-facing data file system before updating those drives' firmware.

After operation 806, process flow 800 moves to 808, where process flow 800 ends.

FIG. 9 illustrates an example process flow 900 for per-neighborhood drive firmware update parallelism for a scale-out clustered file system, in accordance with an embodiment of this disclosure. In some examples, one or more embodiments of process flow 900 can be implemented by system architecture 100 of FIG. 1, or computing environment 1100 of FIG. 11.

It can be appreciated that the operating procedures of process flow 900 are example operating procedures, and that there can be embodiments that implement more or fewer operating procedures than are depicted, or that implement the depicted operating procedures in a different order than as depicted. In some examples, process flow 900 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 1000 of FIG. 10.

Process flow 900 begins with 902, and moves to operation 904.

Operation 904 depicts, where the node supports two entities that are configured to access data from the group of storage drives, wherein each entity has separate failure tolerance constraints, determining respective numbers of partitions of the respective storage drives. In some examples, this can be implemented in a similar manner as operation 310 of FIG. 3.

After operation 904, process flow 900 moves to operation 906.

Operation 906 depicts ordering the respective storage drives based on the respective numbers of partitions, to produce an ordering. In some examples, this can be implemented in a similar manner as operation 312 of FIG. 3.

After operation 906, process flow 900 moves to operation 908.

Operation 908 depicts rebalancing mirrors from a first part of the ordering to a second part of the ordering. In some examples, this can be implemented in a similar manner as operation 324 of FIG. 3.

After operation 908, process flow 900 moves to operation 910.

Operation 910 depicts updating the firmware for the first part of the ordering in parallel. In some examples, this can be implemented in a similar manner as operation 334 of FIG. 3.

After operation 910, process flow 900 moves to 912, where process flow 900 ends.

FIG. 10 illustrates an example process flow 1000 for per-neighborhood drive firmware update parallelism for a scale-out clustered file system, in accordance with an embodiment of this disclosure. In some examples, one or more embodiments of process flow 1000 can be implemented by system architecture 100 of FIG. 1, or computing environment 1100 of FIG. 11.

It can be appreciated that the operating procedures of process flow 1000 are example operating procedures, and that there can be embodiments that implement more or fewer operating procedures than are depicted, or that implement the depicted operating procedures in a different order than as depicted. In some examples, process flow 1000 can be implemented in conjunction with one or more embodiments of one or more of process flow 300 of FIG. 3, process flow 400 of FIG. 4, process flow 500 of FIG. 5, process flow 600 of FIG. 6, process flow 700 of FIG. 7, process flow 800 of FIG. 8, and/or process flow 900 of FIG. 9.

Process flow 1000 begins with 1002, and moves to operation 1004.

In some examples, process flow 1000 can be implemented in conjunction with process flow 900 of FIG. 9, where operation 1004 is implemented after operation 910.

Operation 1004 depicts, after updating the firmware for the first part of the ordering, rebalancing mirrors from the second part of the ordering to the first part of the ordering. In some examples, this can be implemented in a similar manner as operation 324 of FIG. 3.

After operation 1004, process flow 1000 moves to operation 1006.

Operation 1006 depicts updating the firmware for the second part of the ordering in parallel. In some examples, this can be implemented in a similar manner as operation 334 of FIG. 3.

After operation 1006, process flow 1000 moves to 1008, where process flow 1000 ends.

### Example Operating Environment

In order to provide additional context for various embodiments described herein, FIG. 11 and the following discussion are intended to provide a brief, general description of a suitable computing environment 1100 in which the various embodiments of the embodiment described herein can be implemented.

For example, parts of computing environment 1100 can be used to implement one or more embodiments of cluster 102 and/or remote computer 106 of FIG. 1.

In some examples, computing environment 1100 can implement one or more embodiments of the process flows of FIGS. 3-10 to facilitate per-neighborhood drive firmware update parallelism for a scale-out clustered file system.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a nonvolatile storage such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples, and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1116 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### CONCLUSION

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
at least one processor; and
at least one memory that stores executable instructions that, when executed by the at least one processor, facilitate performance of operations, comprising:
maintaining a computer cluster that comprises a group of nodes, wherein a node of the group of nodes comprises a group of storage drives, wherein the node is a member of a failure domain that comprises a subgroup of nodes of the group of nodes, wherein the failure domain is configured to preserve data stored in the failure domain when at least one node within the failure domain fails;
obtaining a reservation for the node, wherein the reservation permits the node to make the group of storage drives unavailable for data access, and wherein other nodes within the failure domain are unable to obtain the reservation while the node possesses the reservation; and
while the node possesses the reservation, updating firmware for respective storage drives for the group of storage drives in parallel.

2. The system of claim 1, wherein the operations further comprise:
based on determining that the node supports mirrored operating system partitions,
determining respective numbers of partitions of the respective storage drives,
ordering the respective storage drives based on a descending number of the respective numbers of partitions, to produce an ordering of drives,
dividing the ordering of drives into a first portion of the ordering and a second portion of the ordering,
rebalancing first mirrors from the first portion of the ordering to the second portion of the ordering,
updating the firmware for the first portion of the ordering in parallel,
rebalancing second mirrors from the second portion of the ordering to the first portion of the ordering, and
updating the firmware for the second portion of the ordering in parallel.

3. The system of claim 1, wherein the node is a first node, and wherein the operations further comprise:
updating the firmware for the node sequentially with updating the firmware for a second node of the failure domain.

4. The system of claim 3, wherein the second node obtains the reservation before updating the firmware for the second node.

5. The system of claim 1, wherein the failure domain is a first failure domain, and wherein the operations further comprise:
updating the firmware on the first failure domain in parallel with updating the firmware on a second failure domain.

6. The system of claim 5, wherein the reservation is a first reservation of the first failure domain, and wherein updating the firmware on the second failure domain comprises nodes of the second failure domain obtaining a second reservation of the second failure domain.

7. The system of claim 1, wherein the operations further comprise:
filtering out drives from the group of storage drives that fail to satisfy a health criterion, to produce a filtered group of storage drives, wherein the updating of the firmware is performed on the filtered group of storage drives.

8. A method, comprising:
determining, by a system comprising at least one processor, to update firmware for a group of storage drives of a group of nodes, wherein a node of the group of nodes is a member of a failure domain;
obtaining, by the system, a reservation for the node, wherein other nodes within the failure domain are unable to obtain the reservation while the node possesses the reservation; and
while the node possesses the reservation, concurrently updating, by the system, the firmware for respective storage drives for the group of storage drives.

9. The method of claim 8, further comprising:
where the node supports two entities that are configured to read and write data from the storage drives, wherein each entity has its own constraints as to failure tolerance, determining, by the system, respective numbers of partitions of the respective storage drives;
ordering, by the system, the respective storage drives based on the respective numbers of partitions, to produce an ordering of drives;
rebalancing, by the system, mirrors from a first part of the ordering of drives to a second part of the ordering of drives; and
concurrently updating, by the system, the firmware for the first part of the ordering of drives.

10. The method of claim 9, further comprising:
after updating the firmware for the first part of the ordering, rebalancing, by the system, mirrors from the second part of the ordering of drives to the first part of the ordering of drives; and
concurrently updating, by the system, the firmware for the second part of the ordering of drives.

11. The method of claim 8, wherein obtaining the reservation for the node comprises:
performing at least one iteration of attempting to obtain the reservation until obtaining the reservation succeeds; and
updating the firmware after obtaining the reservation succeeds.

12. The method of claim 11, wherein attempting to obtain the reservation succeeds where no other node of the failure domain has the reservation.

13. The method of claim 11, wherein attempting to obtain the reservation fails where another node of the failure domain has the reservation.

14. The method of claim 8, further comprising:
releasing, by the system, the reservation after concurrently updating the firmware for the respective storage drives for the group of storage drives.

15. A non-transitory computer-readable medium comprising instructions that, in response to execution, cause a system comprising at least one processor to perform operations, comprising:
obtaining a reservation for a node of a failure domain, wherein other nodes within the failure domain are unable to obtain the reservation while the node possesses the reservation; and
while the node possesses the reservation, updating firmware for respective storage drives of the node in parallel.

16. The non-transitory computer-readable medium of claim 15, wherein the operations further comprise:
where the node supports two entities that are configured to access data from the group of storage drives, wherein each entity has separate failure tolerance constraints, determining respective numbers of partitions of the respective storage drives;
ordering the respective storage drives based on the respective numbers of partitions, to produce an ordering;
rebalancing mirrors from a first part of the ordering to a second part of the ordering; and
updating the firmware for the first part of the ordering in parallel.

17. The non-transitory computer-readable medium of claim 16, wherein the operations further comprise:
after updating the firmware for the first part of the ordering, rebalancing mirrors from the second part of the ordering to the first part of the ordering; and
updating the firmware for the second part of the ordering in parallel.

18. The non-transitory computer-readable medium of claim 15, wherein a computer cluster comprises a group of failure domains, wherein the group of failure domains comprises the failure domain, and wherein a firmware update for the computer cluster is determined to be complete where respective firmware updates for respective failure domains of the group of failure domains are complete.

19. The non-transitory computer-readable medium of claim 15, wherein a computer cluster comprises the failure domain, wherein user input data that is indicative of starting a firmware update is received from a computer at a cluster management component of the system, and wherein the cluster management component sends the node an indication to start the firmware update.

20. The non-transitory computer-readable medium of claim 15, wherein updating the firmware for the respective storage drives is performed after removing the respective storage drives from a user-facing file system.
